(19) United States
(12) Patent Application Publication
(10) Pub. No.: US 2016/0242467 A1
(43) Pub. Date: Aug. 25, 2016

(54) FLAVOR MODULE

(71) Applicant: Roger E. VAUGHN, Cottontown, TN (US)

(72) Inventor: Roger E. VAUGHN, Cottontown, TN (US)

(21) Appl. No.: 15/051,530

(22) Filed: Feb. 23, 2016

Related U.S. Application Data
(60) Provisional application No. 62/119,536, filed on Feb. 23, 2015.

(51) Int. Cl. A24F 47/00; B01F 3/02; B01F 5/04; B01F 3/04

(52) U.S. Cl. CPC A24F 47/008; B01F 3/04049; B01F 3/022; B01F 5/0413

(57) ABSTRACT

A flavor apparatus comprising a flavoring reservoir configured to hold a liquid flavoring, a central conduit and a nozzle operably connected to the flavoring reservoir and configured to atomize the liquid flavoring and provide atomized flavoring to the central conduit.

### CROSS REFERENCE TO RELATED PATENT APPLICATION

This application claims the benefit of U.S. Provisional Application No. 62/119,536, filed Feb. 23, 2015, the contents of which are incorporated by reference in its entirely.

### FIELD

The present invention relates generally to a vaporizer accessory. More specifically, the present invention relates to an accessory that provides flavor to the vaporizer.

### BACKGROUND

Vaporizers, such as E-cigarettes, are increasingly popular as a more health-conscious public has increasingly moved away from cigarettes and other smoked tobacco products. Improving the flavor of the paper inhaled improves the experience for the user.

### SUMMARY

An embodiment is drawn to a flavor apparatus comprising a flavoring reservoir configured to hold a liquid flavoring, a central conduit and a nozzle operably connected to the flavoring reservoir and configured to atomize the liquid flavoring and provide atomized flavoring to the central conduit.

Another embodiment is drawn to a method of adding flavoring to an E-cigarette vapor comprising providing a nicotine containing vapor to a central conduit of a flavor apparatus, atomizing a flavoring liquid in the flavoring apparatus and providing atomized flavoring to the central conduit and mixing the atomized flavoring with the nicotine containing vapor.

### BRIEF DESCRIPTION OF THE DRAWINGS

FIG. 1 is a side schematic illustration of a flavor apparatus according to an embodiment.

FIG. 2 is a side schematic illustration of a flavor apparatus of FIG. 1 attached to a vaporizer according to an embodiment.

FIG. 3 is a side schematic illustration of a flavor apparatus according to another embodiment.

FIG. 4A is a side schematic illustration of vaporizer without a flavor apparatus attached.

FIG. 4B is a side schematic illustration of the flavor apparatus of FIG. 3 attached to a vaporizer.

FIG. 5 is a side schematic illustration of a flavor apparatus according to another embodiment.

FIG. 6 is a side schematic illustration of the flavor apparatus of FIG. 5 attached to a vaporizer.

FIG. 7A is a side schematic illustration illustrating another embodiment.

FIG. 7B is a schematic illustration of a vent cover for reservoirs, tanks lacking an adjustable vent.

FIG. 8 is a side schematic illustration of a conventional E-cigarette.

FIG. 9 is a side schematic illustration of a conventional flavor module for an E-cigarette.

FIG. 10A is a side schematic illustration a flavor apparatus according to an embodiment.

FIG. 10B is a side schematic illustration of a detail of the embodiment illustrated in FIG. 10A

FIG. 11 is a side schematic illustration a flavor apparatus according to an embodiment.

### DETAILED DESCRIPTION

Embodiments of the present invention include tanks that mix flavor with the vapor from the vaporizer. In an embodiment, the vaporizer includes a battery-powered atomizer that heats the fluid to be vaporized. In an embodiment, the flavor fluid is provided in its own separate tank. That is, the unflavored fluid and the flavored fluid are stored in different tanks.

In an embodiment, the flavored fluid is added to the vapor via a Venturi that creates a vapor-like spray that mixes with the unflavored vapor. In an embodiment, the apparatus includes a filter to absorb any non-vaporized fluid. In an embodiment, the apparatus includes a tank that has a generally round shape. However, any suitable shape may be used, such as hexagonal, octagonal, etc. The tank may be made of any suitable material, such as plastic, aluminum and the like. In an embodiment, the tank may hold 0.5-10 ml, such as 1-5 ml, such as 2-5 ml.

As discussed in more detail below, the apparatus may by removably affixed to a standard vaporizer, such and an E-cigarette. In an embodiment, the apparatus includes a Venturi tube that operably connects a flavor reservoir to the conduit supplying the nicotine vapor. The atomized flavor droplets mixes with the nicotine vapor produced and atomized by heating the nicotine containing fluid in its own separate tank with a battery powered atomizer.

In an embodiment, the apparatus is made of injection molded plastic. In an embodiment, the apparatus is includes a liquid flavoring. As discussed above, a Venturi may be used to create a vapor-like spray which mixes with the nicotine containing vapor traveling through the center tube. In an embodiment, the apparatus may include a filter in a front (downstream) portion of the apparatus to absorb any non-vaporized fluid.

In a preferred embodiment, the apparatus is designed to plug into a standard atomizer, such as a 510 or KR808 using a standard 510 or KR808 connector. In an embodiment, the apparatus includes an adjustment mechanism, such as an adjustable vent, to control the amount of flavor that is being delivered. Embodiments of the invention enhance the flavor of vaporizing by mixing a flavoring, such as an oil-based flavoring, with the existing oil-based vapor traveling through the center tube of the vaporizer.

A conventional vaporizer, such as an E-cigarette 100, is illustrated in FIG. 8. The conventional E-cigarette 100 includes a battery module 104 which provides power to the E-cigarette 100. Typically, the conventional E-cigarette 100 also includes an indicator light 102 which indicates if the E-cigarette 100 is on. The indicator light 102 may be configured to mimic the end of a lit cigarette for aesthetics.

The conventional E-cigarette type vaporizer 100 typically includes an atomizer 106 located adjacent to the battery module 104. A liquid reservoir/tank 108 is located adjacent the other side of the atomizer 106. In the conventional E-cigarette 100, a nicotine containing liquid is provided to the liquid reservoir/tank 108. In alternative uses, non-nicotine containing liquids may be added to the liquid reservoir/tank 108. An inhaler/tip 110 is attached to the opposite end of the liquid reservoir/tank 108.

When in use, power from the battery module 104 is provided to the atomizer 106. Heat from the atomizer 106 vaporizes the liquid, such as nicotine containing liquid, in the liquid reservoir/tank 108, forming a vapor, such as a nicotine containing vapor. The vapor is inhaled by the user via the inhaler/tip 110.

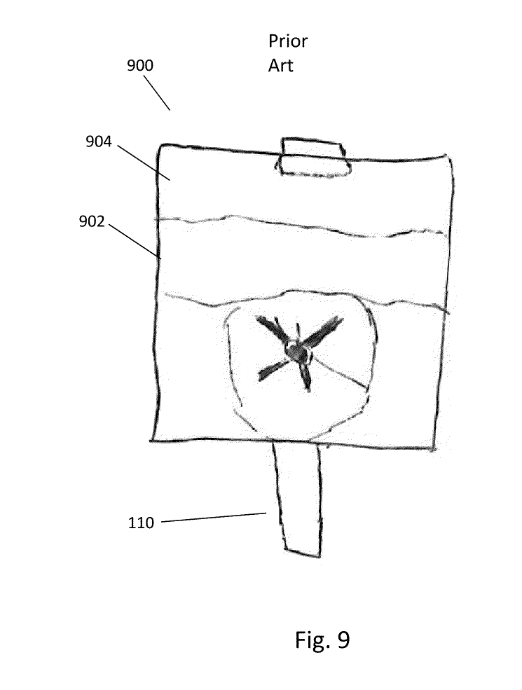

Traditionally, a nicotine containing liquid is not flavored. FIG. 9 illustrates a conventional after-market flavor module 900 that may be added to a conventional E-cigarette 100. The after-market flavor module 900 is inserted between the nicotine liquid reservoir/tank 108 and the inhaler/tip 110. The flavor module 900 includes a reservoir 904 that is provided with a flavoring and a wick 902 between the reservoir 904 and the inhaler/tip 110. As the vapor is sucked past the wick 902, flavor is added to the vapor. This design however, tends not have consistent flavor addition due to absorption of flavor liquid into the wick 902. Additionally, the wick tends to block the flow of vapor from the liquid reservoir/tank 108.

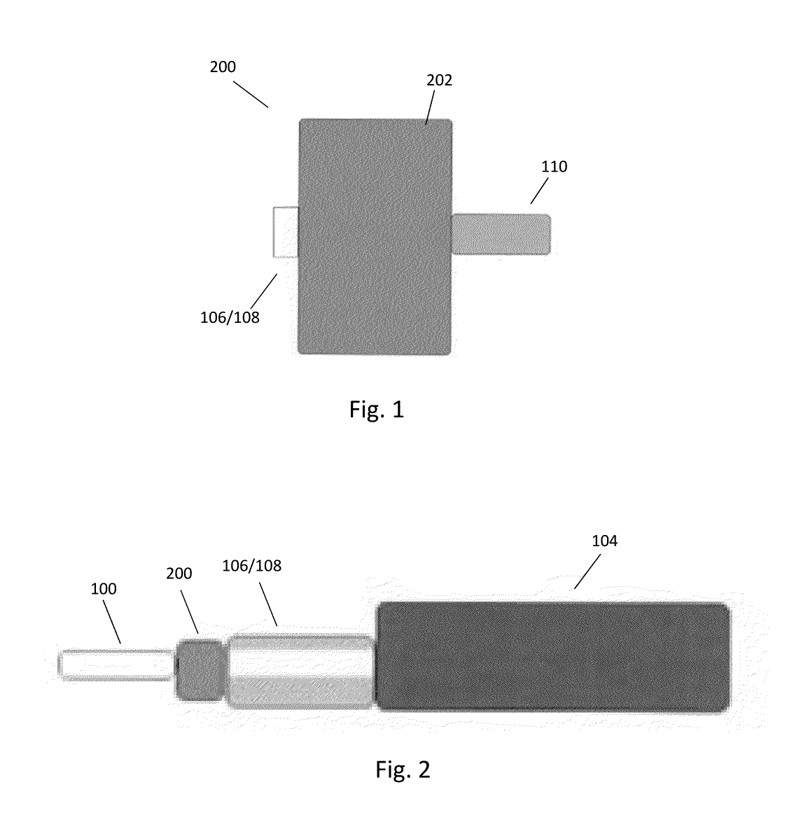

FIG. 1 illustrates and improve flavor apparatus 200. The flavor apparatus 200 includes a flavor reservoir/tank 202. As discussed above, the flavor apparatus 200 is designed to attach to and operate with conventional vaporizers 100. Preferably, the flavor apparatus 200 is located between the atomizer 106/liquid reservoir/tank 108 and the inhaler/tip 110 of the conventional vaporizers 100 as illustrated in FIG. 2.

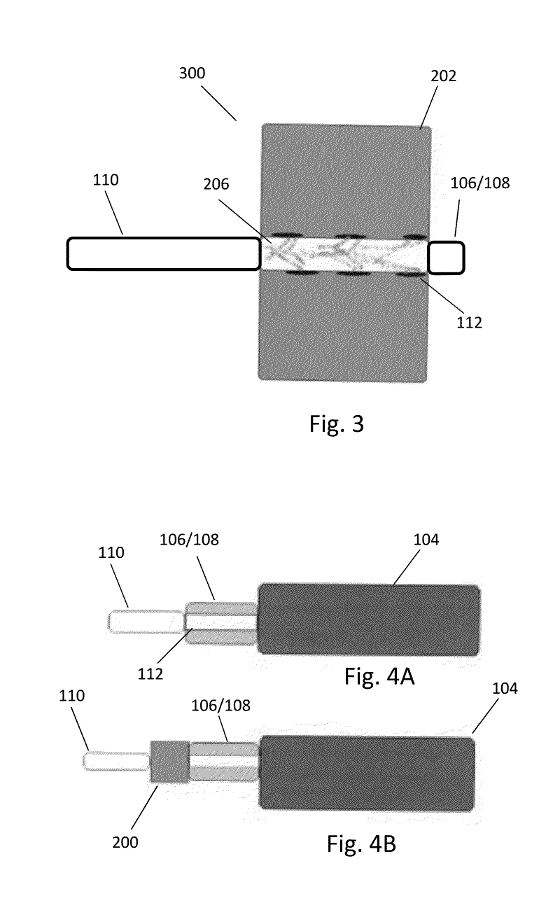

FIG. 3 illustrates the details of a flavor apparatus 300 according to an embodiment. As illustrated in FIG. 3, the flavor apparatus 300 includes a cylindrical reservoir/tank 202 which surrounds a central conduit 112. Vapor from the atomizer 106/liquid reservoir/tank 108 enters one end of the central conduit 112. Liquid flavoring in the cylindrical reservoir/tank 202 is provided to one or more nozzles, discussed in more detail below. The nozzles atomize the liquid flavoring and inject atomized flavoring 206 into the central conduit 112. The atomized flavoring 206 mixes with the vapor from the atomizer 106/liquid reservoir/tank 108 in the central conduit 112. The flavored vapor may then be inhaled by the user via the inhaler/tip 110.

FIGS. 4A and 4B another embodiment. FIG. 4A illustrates a vaporizer without the flavor apparatus 200. FIG. 4B illustrates the flavor apparatus 200 located between the atomizer 106/liquid reservoir/tank 108 and the inhaler/tip 110.

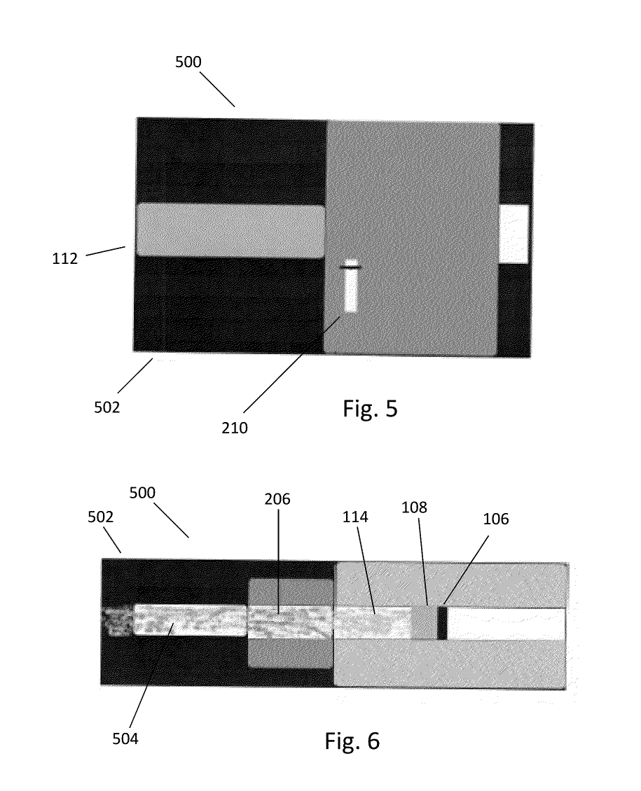

FIGS. 5 and 6 illustrate another embodiment of a flavor apparatus 500. This embodiment includes a housing 502 which covers the flavor tank/reservoir 202 and at least a portion of the inhaler/tip 110. This embodiment also includes an adjustment mechanism 210. The adjustment mechanism 210 may be, for example, an adjustable air vent. As discussed in more detail below, the adjustment mechanism 210 may be used to adjust the amount of flavoring provided to the central conduit 112.

As illustrated in FIG. 6, the atomizer 106 heats the liquid reservoir 108, generating vapor 114. The vapor 114 is provided to the central conduit 112 of the flavor apparatus 500 where it mixes with atomized flavoring 206. The flavored vapor 504 is provided to the inhaler/tip 110.

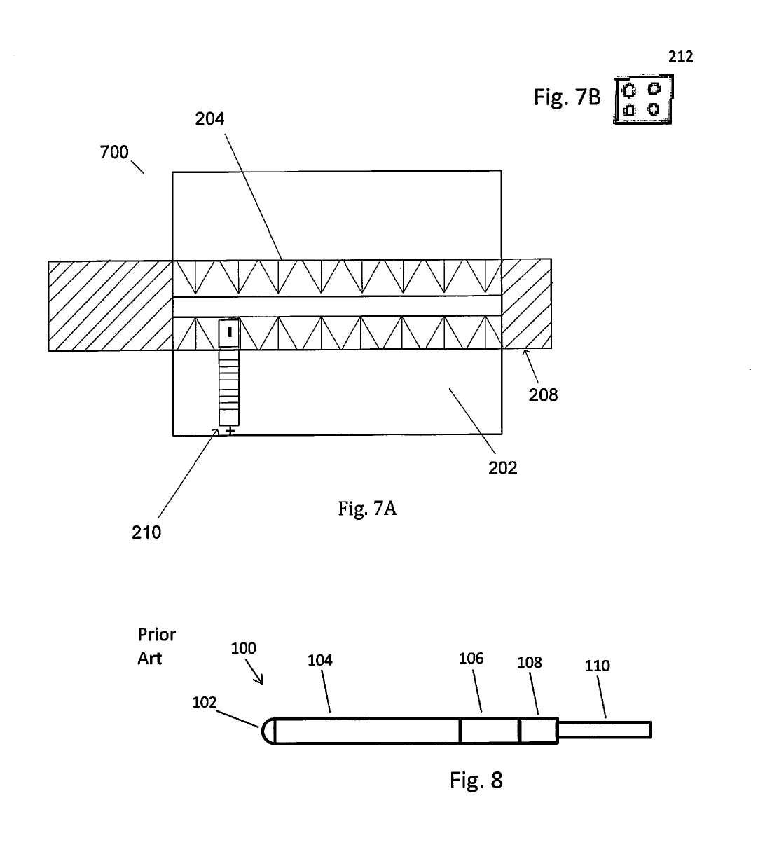

FIG. 7A illustrates another embodiment of a flavor apparatus 700. This embodiment includes a plurality of flavor delivery mechanisms 204. In an embodiment, the flavor delivery mechanisms 204 are nozzles. FIG. 7B illustrates a vent cover for a flavor apparatus 700 that includes a flavor tank/reservoir 204 that lacks an adjustable vent. In this embodiment, the flavor apparatus 700 may include a filter 208 located to prevent or absorb liquid from passing from the central conduit 112 to the inhaler/tip 110. That is, should some of the vapor in the central conduit 112 cool and condense, the filter 208 prevents it from reaching the user.

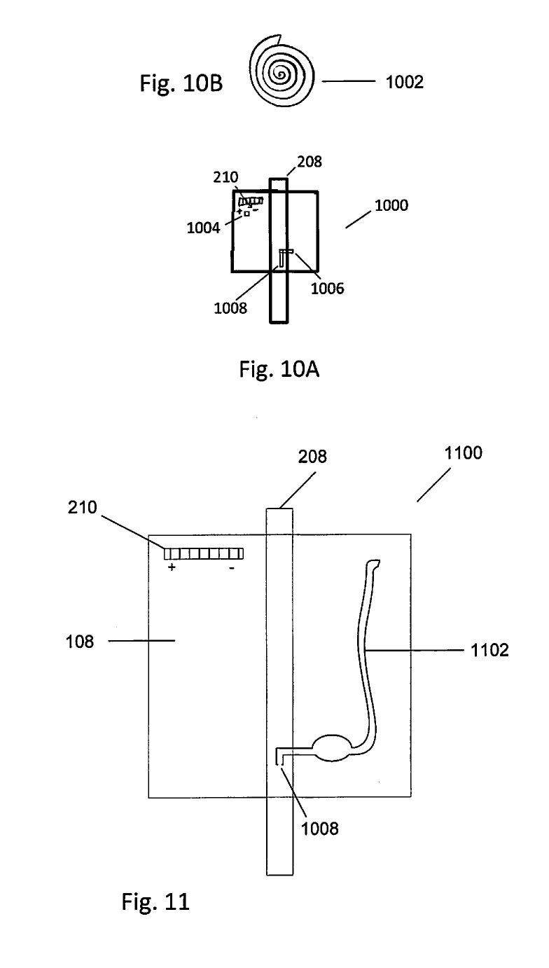

FIGS. 10A and 10B illustrate a flavor apparatus 1000 according to another embodiment. Rather than a cylindrical reservoir 108, this embodiment includes a coiled tube reservoir 1002 to hold the liquid flavoring. The coiled tube reservoir 1002 may be wrapped around the central conduit 112. One end of the coiled tube reservoir 1002 may be connected to a back port 1004 and the other end of the coiled tube reservoir 1002 may be connected to a front port 1006. In an embodiment, the back port 1004 is located adjacent to and operable coupled to an adjustment mechanism 210. The front port 1006 is operably connected to a nozzle 1008 configured to provide atomized flavoring to the central conduit 112.

FIG. 11 illustrates a flavor apparatus 1100 according to an embodiment. In this embodiment, the cylindrical reservoir/tank 108 includes a small feed tube 1102 which is operable connected to a nozzle 1008 configured to provide atomized flavoring to the central conduit 112. As in the previous embodiment, this embodiment may also include an adjustment mechanism 210, such as an adjustable air vent.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A flavor apparatus comprising:
a flavoring reservoir configured to hold a liquid flavoring;
a central conduit; and
a nozzle operably connected to the flavoring reservoir and configured to atomize the liquid flavoring and provide atomized flavoring to the central conduit.

2. The apparatus of claim 1, wherein the flavoring reservoir comprises a coiled tube surrounding the central conduit.

3. The apparatus of claim 1, wherein the apparatus is configured to provide flavoring to an E-cigarette.

4. The apparatus of claim 1, further comprising an adjustment mechanism allowing control of the flow of atomized flavoring to the central conduit.

5. The apparatus of claim 4, wherein the adjustment mechanism is an adjustable air vent.

6. The apparatus of claim 1, wherein the atomized flavoring is mixed with a nicotine containing vapor in the central conduit.

7. The apparatus of claim 1, further comprising a Venturi operably connected to the nozzle.

8. The apparatus of claim 6, further comprising a filter located to prevent liquid containing nicotine from entering the central conduit.

9. A method of adding flavoring to an E-cigarette vapor comprising:
providing a nicotine containing vapor to a central conduit of a flavor apparatus;
atomizing a flavoring liquid in the flavoring apparatus; and
providing atomized flavoring to the central conduit and mixing the atomized flavoring with the nicotine containing vapor.

10. The method of claim 9, further comprising adjusting the amount of atomized flavoring provided to the central conduit.

11. The method of claim 10, wherein adjusting the amount of atomized flavoring provided to the central conduit is performed by adjusting an air vent.
